(19) United States
(12) Patent Application Publication
(10) Pub. No.: US 2011/0303347 A1
(43) Pub. Date: Dec. 15, 2011

(54) METHOD FOR MANUFACTURING SURFACE MOUNTING CRYSTAL RESONATOR

(75) Inventor: SHUICHI MIZUSAWA, Saitama (JP)

(73) Assignee: NIHON DEMPA KOGYO CO., LTD., TOKYO (JP)

(21) Appl. No.: 13/159,392

(22) Filed: Jun. 13, 2011

(30) Foreign Application Priority Data
Jun. 15, 2010 (JP) 2010-135755

(51) Int. Cl. C03B 29/00

(52) U.S. Cl. 156/89.12

(57) ABSTRACT

A method for manufacturing a surface mounting crystal resonator is provided, in which the bonding strength of low melting point glass is increased and the productivity is also increased. The surface mounting crystal resonator includes a set of container components having at least a crystal sheet 4 hermetically enclosed therein, and low melting point glass 3 bonding opposite-facing peripheral surfaces of the container components for sealing, and the low melting point glass 3 is temporarily fixed by coating the glass paste at the periphery of at least one of the surfaces of the set of container components. A surrounding concave trench is provided in at least one of the opposite-facing peripheral surfaces of the container components, and the low melting point glass 3 is provided at the peripheral surface having the concave trench.

### CROSS-REFERENCE TO RELATED APPLICATION

This application claims the priority benefits of Japan patent application serial no. 2010-135755, filed on Jun. 15, 2010. The entirety of the above-mentioned patent applications is hereby incorporated by reference herein and made a part of specification.

### BACKGROUND OF THE INVENTION

1. Field of the Invention

The present invention relates to a method for manufacturing a surface mounting crystal resonator sealed with glass (hereinafter referred to as a surface mounting resonator), in particular, to a manufacturing method for evenly increasing the bonding strength and having the excellent productivity.

2. Description of Related Art

A crystal resonator has an excessively high Q value that represents the resonance sharpness; hence, a crystal resonator may be used as a resonator in an oscillator or a filter of various electronic machines. Surface mounting resonators are compact and light; thus, they are particularly applicable to portable machines. As such, a surface mounting resonator, for example, a surface mounting resonator sealed with glass is provided. In this situation, compared with a surface mounting resonator sealed with an eutectic alloy for example, a glass seal is relatively cheaper.

FIGS. 8(a), 8(b), and 8(c) are views illustrating a prior example, in which FIG. 8(a) is a sectional view of a surface mounting resonator, FIG. 8(b) is a bottom view of the surface mounting resonator, and FIG. 8(c) is a plan view of the surface mounting resonator without a cover.

The surface mounting resonator is formed by sealing a base substrate 1 and a cover 2 with low melting point glass 3 to form a closed container and enclosing a crystal sheet 4 in the closed container. The base substrate 1 includes laminated ceramic having a bottom wall 1a and a frame wall 1b, and the base substrate 1 has a rectangular shape being viewed from the top and a concave section. On an inner bottom surface of the base substrate 1 (the bottom wall 1a), a pair of crystal retention terminals 5 is provided at two sides of one end of the bottom wall 1a, and surface mounting external terminals 6 are provided at two sides of an outer bottom surface. The crystal retention terminals 5 are electrically connected with the external terminals 6 through a lamination face and end face electrodes (not shown) formed by through hole processing on an outer side surface.

In this situation, for example, a bottom wall wafer and a frame wall wafer (not shown) are first formed by integrating multiple bottom walls 1a and multiple frame walls 1b, and including a ceramic green sheet. Then, circuit patterns of the crystal retention terminals 5, the external terminals 6, and the end face electrodes are printed on each of the rectangular shaped areas of the bottom wall wafer. Afterwards, the frame wall wafer is laminated on the bottom wall wafer and calcined.

Next, Ni and Au plating is performed on the circuit patterns exposed on the surface, so as to form a sheet base substrate. Afterwards, the sheet base substrate is partitioned into base substrates 1. Herein, at the time prior and subsequent to the partition of the sheet base substrate, a glass paste, which is the raw material of the low melting point glass 3, is coated on opening end faces of each of the base substrates 1 through screen mask printing. The glass paste is calcined and temporarily fixed at the opening end face of the base substrate 1. Further, the calcining temperature of the ceramic green sheet is 1600° C., which is excessively higher, comparing with the melting point 400° C. of the low melting point glass 3; accordingly, they are separately calcined.

As the AT-cut, the crystal sheet 4, for example, has an excitation electrode 7a on two main surfaces, and an extraction electrode 7b extending from two sides of an end portion of the crystal sheet. The extraction electrode 7b extending from two sides of an end portion of the crystal sheet 4 is fixed at the crystal retention terminals 5 with, for example, a conductive adhesive 8. Accordingly, the two sides of an end portion of the crystal sheet 4 are electrically and mechanically connected with the crystal retention terminals 5.

Afterwards, the peripheral surface of the cover 2 is configured correspondingly to an opening end face (an upper surface of the frame wall 1b) of the base substrate 1 containing the crystal sheet 4 therein and is abutted to the opening end face. Then, heating is performed at a temperature higher than the melting point of the low melting point glass 3, and a load of about 200 g is applied. Accordingly, the peripheral surface of the cover 2 is hermetically bonded with the low melting point glass 3 disposed at the opening end face of the base substrate 1, so as to hermetically enclose the crystal sheet 4. The cover 2 includes ceramic, for example, and is slightly smaller than the plane shaped base substrate 1.

### PRIOR TECHNICAL DOCUMENTATION

### Patent Documentation

Patent Documentation 1: JP Patent Publication No. 2000-165180
Patent Documentation 2: JP Patent Publication No. 2008-236741

However, in the surface mounting resonator constructed as discussed above, there are problems of lower and uneven bonding strength with the low melting point glass 3 for the bonding of the base substrate 1 and the cover 2. Alternatively speaking, the low melting point glass 3 facing the opening end face of the base substrate 1 is formed by printing and calcining the glass paste. In this situation, as shown in FIG. 9, for example, the glass paste 3A is liquid; hence, it is printed into a semi-cylindrical shape with the centre protruding due to surface tension, and undulations of concavities and convexities are generated in the direction surrounding the central protrusion. Moreover, the above condition is maintained for performing the calcination, and the low melting point glass 3 is temporarily fixed at the periphery of the cover 2.

Therefore, when the peripheral surface of the cover 2 is abutted to the base substrate 1 and calcined, only a front end area of the low melting point glass 3 in a semi-cylindrical shape is bonded with the opening end face of the base substrate 1. Therefore, a so-called seal path of a bonding interface becomes shorter, and the bonding strength becomes lower. Accordingly, as described above, just after the low melting point glass 3 is melted, a pressure is applied in a direction as shown by the arrow P, so as to compress the top portion of the semi-cylindrical shaped low melting point glass 3, enlarge the planar portion and eliminate the undulations in the direction surrounding the central protrusion to make the low melting point glass planar. Furthermore, a pressure (a load) is applied to prevent the rising of the cover 2 caused by the expansion of the internal environment during heating.

However, in this case, particularly when multiple objects, for example 1000, are processed totally through a tooling having a heavy article (not shown), the load forces respectively applied are uneven. Moreover, for example, if a load force is excessively large, the glass is exposed undesirably, in which poor productivity is resulted; hence, a small load force is preferred. Therefore, the problems of smaller contact area, and reduced and uneven bonding strength occur.

Also, in the example, the base substrate 1 and the cover 2 are respectively bonded in a single state; hence, the productivity is undesirable. In this case, although the planar section of the base substrate 1 is reduced to restrain the protrusion of the cover 2, the problem of an undesirable appearance due to offset position is generated.

### SUMMARY OF THE INVENTION

Accordingly, the present invention is directed to a method for manufacturing a surface mounting resonator, in which the bonding strength of the low melting point glass is evenly increases and the productivity is also increased.

As shown in a technical solution (technical solution 1), the present invention provides a method for manufacturing a surface mounting crystal resonator, and the surface mounting crystal resonator includes a set of container components in a rectangular shape when being viewed from the top and having at least a crystal sheet hermetically enclosed therein, and opposite-facing peripheral surfaces of the set of container components are bonded through low melting point glass, and the manufacturing method includes at least the following steps.

In a first step, a set of integrated sheet container components provided with rectangular shape areas equivalent to the set of container components respectively is formed, and a trench is formed on at least any one of the peripheral surfaces of the rectangular shape areas of the set of sheet container components. The trench surrounds the peripheral surface.

In a second step, a glass paste is coated on the peripheral surface with the trench, and calcination is then performed, so as to temporarily fix the low melting point glass at the peripheral surface.

In a third step, the crystal sheet is received in the set of container components, the peripheral surface of the rectangular shape area is positioned by facing the set of container components, and another peripheral surfaces of the set of sheet container components is abutted to the low melting point glass temporarily fixed on one of the peripheral surfaces of the set of sheet container components.

In a fourth step, the low melting point glass between the peripheral surfaces of the set of sheet container components is calcined, and the peripheral surfaces of the set of container components are bonded to form a sheet container.

In a fifth step, the sheet container is partitioned vertically and horizontally, so as to obtain individual containers, each having the crystal sheet hermetically enclosed therein.

### EFFECTS OF THE PRESENT INVENTION

According to such a structure, the glass paste is coated on a peripheral surface of a container component with a trench formed thereon, so the glass paste flows into (fills) the trench, and a top portion (a central portion) of glass paste, formed due to surface tension, is planarized. Therefore, when the peripheral surfaces of a set of container components are abutted to be heated and melted, even if a low pressure is applied, the bonding area is increased so as to increase the bonding strength and to provide a uniform bonding strength. Moreover, the low melting point glass is formed on a peripheral surface having the trench; hence, the bonding strength between the low melting point glass and the peripheral surface having the trench formed thereon may be increased.

Furthermore, after being bonded with sheet container component formed by integrating the container components, the sheet container component is partitioned into individual containers, which are the surface mounting resonators, with each having a crystal sheet hermetically enclosed therein. Hence, the productivity is increased. In this case, the planar section of the base substrate and the cover of a set of partitioned container components are of the same size. Therefore, the position offset of the cover relative to the base substrate as in the prior example is precluded.

(Reference Items of the Technical Solution 1)

In a technical solution 2 of the present invention, the trench at the peripheral surface is formed by setting separate concave trenches between adjacent peripheral surfaces and partitioning the concave trenches. In a technical solution 3 of the present invention, the trench at the peripheral surface is formed by setting continuous concave trenches between adjacent peripheral surfaces and partitioning the concave trenches. In a technical solution 4 of the present invention, the set of container components includes a base substrate in a concave shape and a cover in a flat plate shape; alternatively, the set of container components includes a base substrate in a flat plate shape and a cover in a concave shape.

In a technical solution 5 of the present invention, the set of container components includes: a frame, surrounding the crystal sheet and combined through a joint portion; and a base substrate and a cover, having peripheral surfaces bonded with two main surfaces of the frame and separated from the crystal sheet. According to reference items of the technical solution 2 to 5, the formation of the present invention is further clarified.

In order to make the aforementioned features and advantages of the present invention more comprehensible, embodiments are illustrated in detail hereinafter with reference to accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1(a) and 1(b) are views illustrating a first embodiment of the present invention, FIG. 1(a) is a sectional view of a surface mounting resonator, and FIG. 1(b) is a partially enlarged sectional view of a cover being bonded to a base substrate.

FIGS. 2(a) and 2(b) are views illustrating a manufacturing method of the surface mounting resonator of the first embodiment of the present invention, FIG. 2(a) is a plan view of a sheet base substrate, and FIG. 2(b) is a sectional view of the sheet base substrate.

FIG. 3 is a sectional view illustrating a cover being bonded to a base substrate in the manufacturing method of the surface mounting resonator of the first embodiment of the present invention.

FIGS. 4(a) and 4(b) are views illustrating a manufacturing method of a surface mounting resonator of a second embodiment of the present invention, FIG. 4(a) is a partially enlarged view of a sheet base substrate represented with a dash line frame in FIG. 2(a), and FIG. 4(b) is a sectional view of the sheet base substrate.

FIG. 5 is a sectional view illustrating a cover being bonded to a base substrate in the manufacturing method of the surface mounting resonator of the second embodiment of the present invention.

FIG. 6 is a sectional view illustrating a surface mounting resonator of another example according to the first and second embodiments of the present invention.

FIGS. 7(a) and 7(b) are views illustrating a third embodiment of the present invention, FIG. 7(a) is a sectional view of a surface mounting resonator (lamination type), and FIG. 7(b) is a plan view of a crystal sheet with a frame.

FIGS. 8(a), 8(b), and 8(c) are views illustrating a prior example, FIG. 8(a) is a sectional view of a surface mounting resonator, FIG. 8(b) is a bottom view of the surface mounting resonator, FIG. 8(c) is a plan view of the surface mounting resonator without a cover.

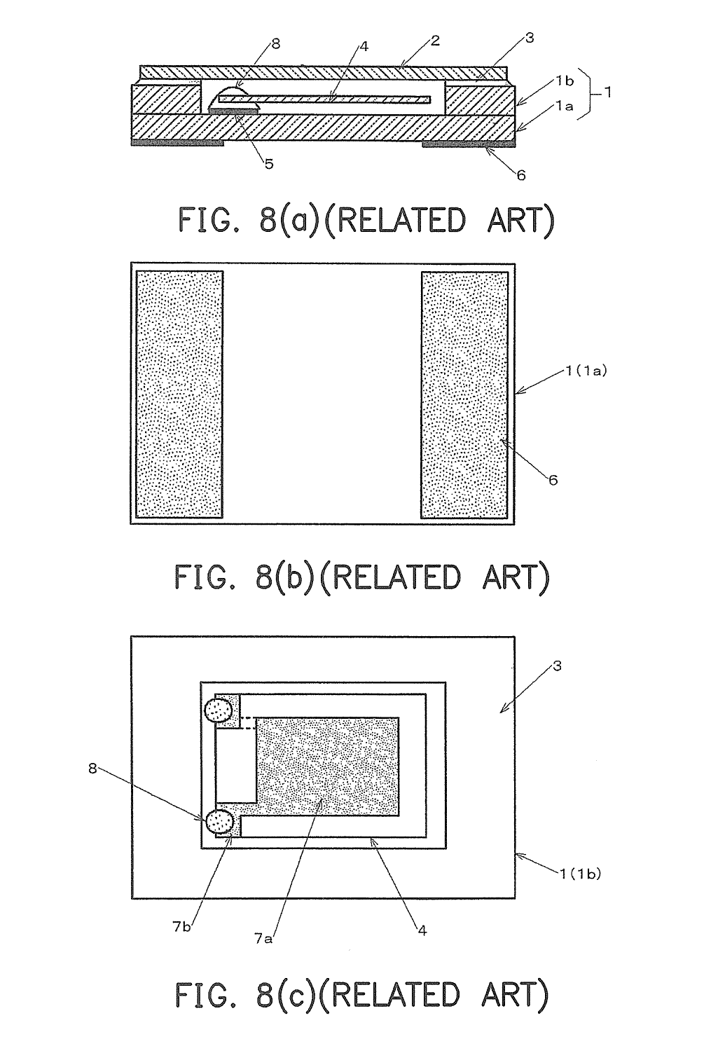

FIG. 9 is a partially enlarged sectional view illustrating a cover being bonded to a base substrate of a prior example.

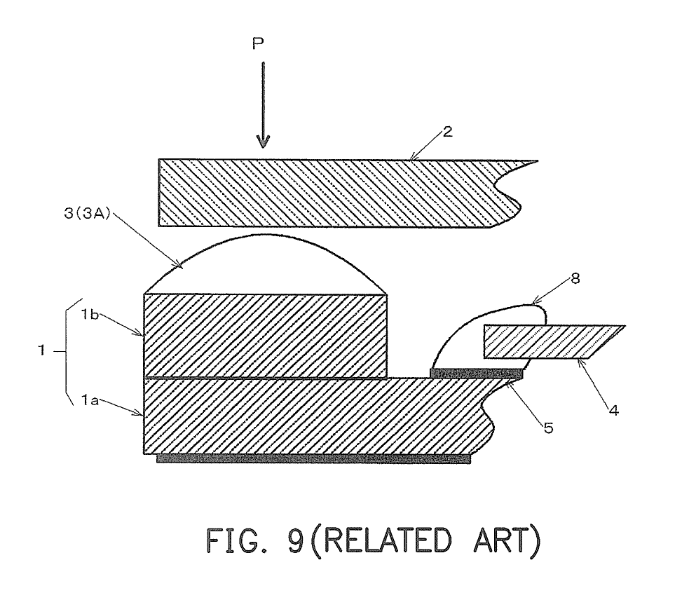

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

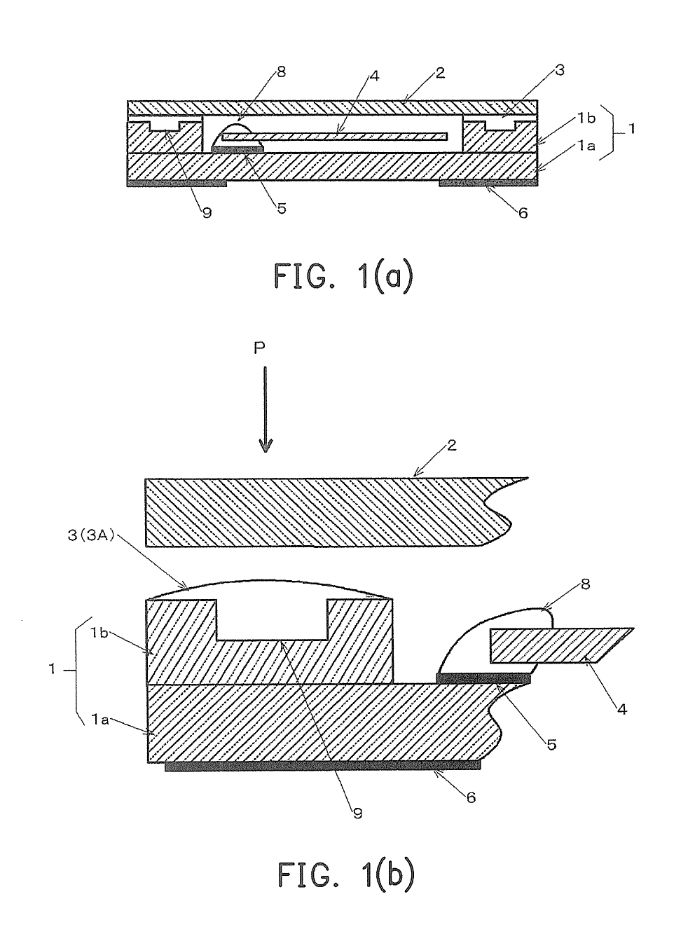

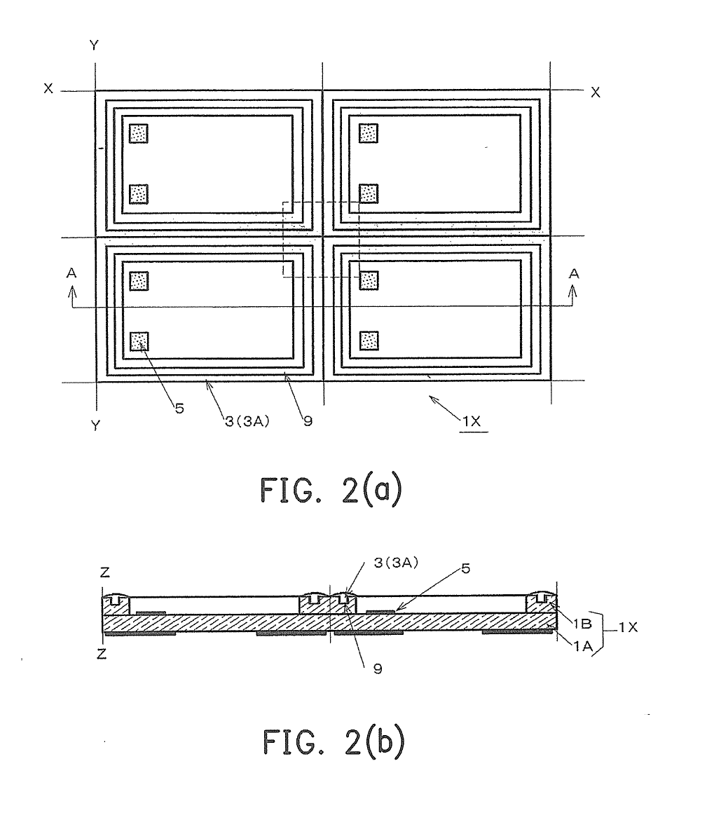

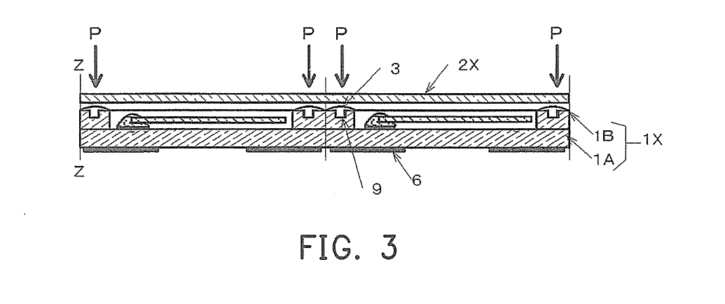

Hereinafter, a manufacturing method of a surface mounting resonator according to the first embodiment of the present invention is illustrated with reference to FIGS. 1(a) and (b) (a sectional view and a partially enlarged sectional view of a surface mounting resonator), FIGS. 2(a) and 2(b) (a plan view and a sectional view of a base substrate wafer) and FIG. 3 (a sectional view of the bonding). Further, the same reference numbers are used in the prior example and the description of the exemplary embodiments of the invention to refer to the same or like parts, and detail explanations thereof are simplified or omitted.

As described above, a surface mounting resonator is formed by hermetically enclosing a crystal sheet 4 in a container. The container is formed of a concave base substrate 1 and a cover 2, and the base substrate 1 has a bottom wall 1a and a frame wall 1b and includes laminated ceramic. The base substrate 1 and the cover 2 are bonded through low melting point glass 3. A crystal retention terminals 5 is provided on an inner bottom surface of the base substrate 1, and a mounting external terminal 6 electrically connected with the crystal retention terminal 5 is provided on an outer bottom surface. Moreover, an extraction electrode 7b extending from an excitation electrode 7a is electrically and mechanically connected to two sides of an end portion of the crystal sheet 4 through a conductive adhesive 8.

In the present embodiment, at the peripheral surface as the opening end face of the base substrate 1, a trench 9 with a concavity at the cross-section thereof (referred to as a concave trench 9), surrounding the peripheral surface of the base substrate 1, is provided. Moreover, the peripheral surfaces of the base substrate 1 including the concave trench 9 and the cover 2 are bonded through the low melting point glass 3. Herein, a glass paste 3A is coated on the peripheral surface of the base substrate 1 including the concave trench 9 through screen mask printing by using a mesh mask.

In this case, the glass paste 3A fills the concave trench 9, and comparing with a situation without the concave trench 9, the top portion (the central portion) of the glass paste 3A forms an obtuse angle and becomes more planar. Specifically, the curvature radius of the circular arc, shaped due to surface tension, becomes larger because of the concave trench 9; hence, the top portion forms an obtuse angle and becomes more planar.

Then, the glass paste 3A is calcined at a temperature higher than a melting point (400° C.) of the low melting point glass 3 and lower than a calcination temperature (1600° C.) of the ceramic of the base substrate 1. The binder in the glass paste 3A is thereby evaporated, and the low melting point glass 3 is temporarily fixed at the peripheral surface of the base substrate 1, that is, the opening end face. In this case, the glass paste 3A is sintered in the above condition, so that the top portion maintains an obtuse angle and becomes more planar.

Finally, similar to the foregoing illustration, the peripheral surface of the cover 2 is abutted to the low melting point glass 3 and a pressure is applied in a direction of the arrow P while the low melting point glass 3 is further calcined. The peripheral surface of the cover 2 is thereby abutted to the planar portion of the low melting point glass 3 and is pressed; hence, comparing with the prior situation, the contact area becomes larger. Moreover, the low melting point glass 3 is melted in the condition with a larger contact area, so the periphery of the cover 2 is bonded with the opening end face of the base substrate 1 to achieve the seal.

With such a structure, as documented in the Invention Effects, the low melting point glass 3 covers the peripheral surface including the concave trench 9; hence, the bonding strength at the peripheral surface (the opening end face) of at least one of the container components, that is, the base substrate 1 may be increased. Moreover, the peripheral surface of the base substrate 1 with the concave trench 9 is coated with the glass paste 3A; therefore, the glass paste 3A flows into (and fills) the concave trench 9, and the top portion (the central portion), formed due to the surface tension of the glass paste 3A, is planarized. Therefore, even if a lower pressure (including 0) is applied, when the peripheral surface abutted to the cover 2 is heated and melted, the contact area also becomes larger, and the bonding strength is increased and more uniform.

Further, the foregoing example describes the manufacturing method of a single surface mounting resonator. Specifically, as shown in FIGS. 2(a) and 2(b), after the ceramic green sheet being integrally formed, individual surface mounting resonators are formed after partitioning. In essence, in a frame wall wafer 1B including the ceramic green sheet, a concave trench 9 is formed at a peripheral surface of each frame wall 1b through pressing machining. Then, the frame wall wafer 1B is laminated onto a bottom wall wafer 1A constructed with circuit patterns, such as crystal retention terminals 5 or external terminals 6, and a sheet base substrate 1X is formed after calcination and plating.

Thereafter, the glass paste 3A is coated at the peripheral surface of an upper surface (an opening end face) of each frame wall of the sheet base substrate 1X and the concave trench 9, through the screen mask printing. In this case, the glass paste 3A is independently formed between upper surfaces of adjacent frame walls corresponding to the upper surface of each frame wall. Alternatively speaking, the glass paste 3A is basically separated from one another. However, for convenience, the glass paste 3A is illustrated as being continuous in the drawings. Moreover, the glass paste 3A is calcined, so that the low melting point glass 3 is temporarily fixed at the upper surface (the peripheral surface) of the frame wall.

Thereafter, a sheet cover 2X is located and positioned on the upper surface of the sheet base substrate 1X, and the peripheral surface of each cover 2 is abutted to the low melting point glass 3 on the upper surface (the peripheral surface) of the frame wall of each base substrate 1. Afterwards, a pressure is applied to the entire sheet cover 2X from the top of the sheet cover 2X, and the low melting point glass 3 is melted. The sheet cover 2X is thereby bonded with the sheet base substrate 1X, so as to obtain a sheet container. Finally, as shown in FIG. 3, the sheet container is partitioned along partition lines X-X and Y-Y in the thickness direction (Z-Z), so as to obtain surface mounting resonators.

In this case, similar to the foregoing, a top portion of each low melting point glass 3 is planarized, so that the contact area between the top portion and the peripheral surface of the cover 2 becomes larger. Hence, even if the applied pressure is small, the bonding strength is evenly increased. Moreover, the sheet container is partitioned after the sheet base substrate 1X and the sheet cover 2X are bonded, the productivity is thereby increased. Further, for the sake of convenience, in FIG. 2 and FIG. 3, the number of the base substrate 1 is set to be 4, but in practical application, the number of base substrate could be about 500.

### Second Embodiment

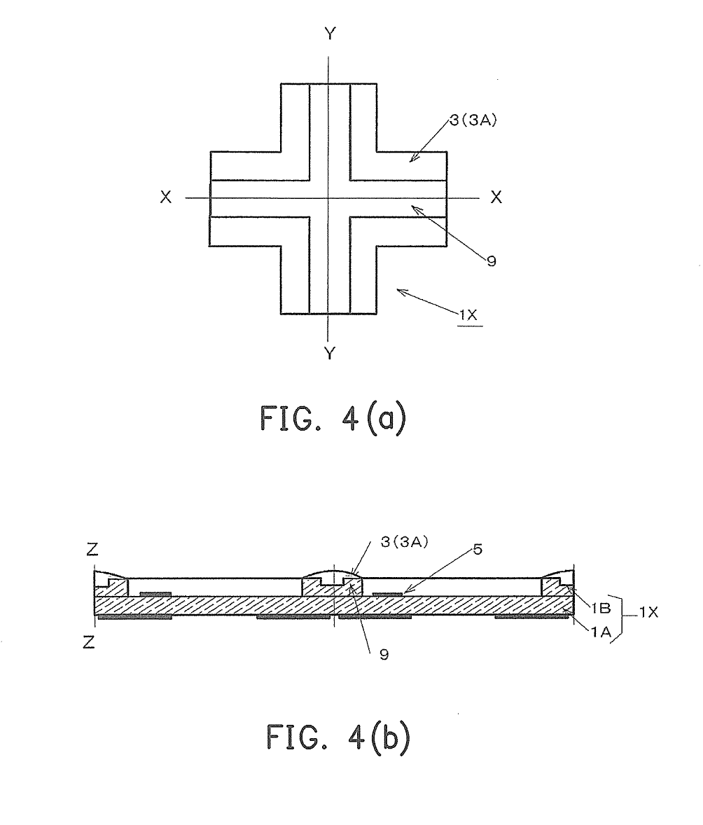

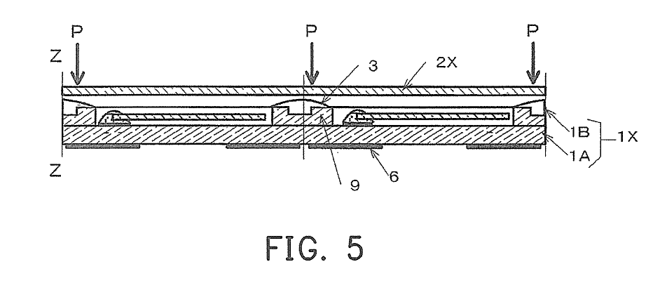

Hereinafter, a manufacturing example of surface mounting resonator of the second embodiment of the present invention is illustrated with reference to FIGS. 4(a) and 4(b) and FIG. 5. FIG. 4(a) is a partially enlarged view of a sheet base substrate inside the dash line frame in FIG. 2(a), FIG. 4(b) is a sectional view of the sheet base substrate, and FIG. 5 is a sectional view of a cover being bonded to a base substrate.

In the second embodiment, the continuous concave trenches 9 (continuous concave trenches 9A) are formed between adjacent peripheral surfaces of different base substrates 1 of a sheet base substrate 1X. Moreover, the peripheral surfaces including the continuous concave trenches 9A are coated with glass paste 3A, and the glass paste 3A is calcined to be temporarily fixed.

Then, the sheet cover 2X is disposed on the sheet base substrate 1X, and adjacent peripheral surfaces of the covers 2 are abutted to the low melting point glass 3 on upper surfaces of continuous frame walls of the base substrates 1. Then, the low melting point glass 3 is calcined, and the sheet cover 2X is bonded onto the upper surface of the sheet base substrate 1. Finally, partitioning is performed along the directions of the partition lines X-X and Y-Y, Z-Z to obtain the surface mounting resonators.

With such a structure, similar to that of the first embodiment, an overlapping portion of the low melting point glass at the peripheral surfaces including the continuous concave trenches 9A disposed at adjacent peripheral surfaces is planarized. Therefore, with the low melting point glass 3 at upper surfaces (opening end faces) of the frame walls as adjacent peripheral surfaces of the base substrates 1, the contact area of the adjacent peripheral surfaces of the covers becomes larger. Accordingly, even if a lower pressure is applied, the bonding strength may also be evenly increased. In this case, after the partitioning of the sheet container, the bonding area between the low melting point glass 3 of the base substrate 1 and the peripheral surface of the cover 2 is large, so the bonding strength may be evenly increased.

### Variation of the First and Second Embodiments

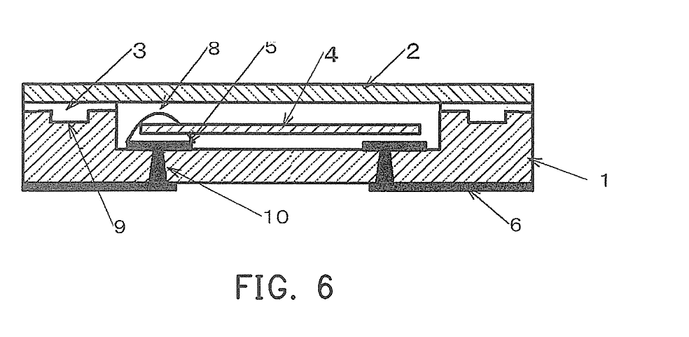

In the first and second embodiments, the base substrate 1 is formed of laminated ceramic, and the cover 2 is formed of ceramic. However, the present invention is not limited as such, and both the base substrate 1 and the cover may be formed of glass or crystal. Furthermore, the cover 2 may also be formed of metal. In this case, for example, as shown in FIG. 6 (a sectional view), the concave trench 9 of the base substrate 1 is formed through wet etching or dry etching. Moreover, a pair of crystal retention terminals 5 is connected with the external terminals 6 via through electrodes (through holes) 10 disposed in the inner wall, and are sealed through, for example, the melting of a metal part.

Also, the concave trench 9 is disposed on the opening end face (the upper surface of the frame wall) as the peripheral surface of the base substrate 1. However, even if the concave trench 9 is disposed on the peripheral surface of the cover 2, the same effects may also be achieved. In this case, after the peripheral surface of the cover 2 is coated with the glass paste 3A from the top and the glass paste 3A is calcined to be temporarily fixed, the cover 2, similar to the forgoing, is inverted and is configured on the opening end face of the base substrate 1 and calcinations is performed. In brief, the cover 2 is configured at the upper side and the base substrate 1 is configured at the lower side. Alternatively, the positioning is performed with the cover 2 configured at the lower side and the base substrate 1 configured at the upper side, and then the calcination is performed.

Also, even if the base substrate 1 has a flat plate shape and the cover 2 has a concave shape, the same effects may also be achieved. Moreover, the concave trench 9 is designed to have a square shaped section, which are examples of certain embodiments of the invention and should not be construed as limiting the scope of the invention. In other exemplary embodiments, the section may also be in a circular arc shape or a V shape, as long as a recess enabling the filling of the glass paste 3A of the low melting point glass 3 is provided. Furthermore, in addition to receiving the crystal sheet 4, the base substrate 1 may further receive, for example, an Integrated Circuit (IC) chip forming an oscillation circuit. Further, the base substrate 1 and the cover 2 are equivalent to a set of container components in the technical solution.

### Third Embodiment

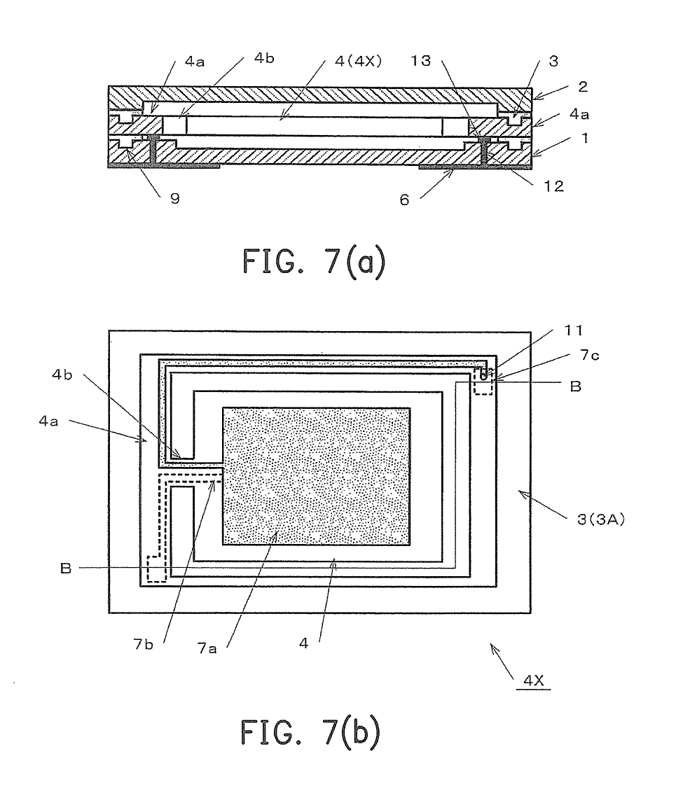

FIGS. 7(a) and 7(b) are views illustrating a surface mounting resonator of a third embodiment of the present invention, FIG. 7(a) is a sectional view of a surface mounting resonator, and FIG. 7(b) is a plan view of a crystal sheet with a frame. Further, illustration of parts the same as those in the first embodiment is simplified or omitted.

In the third embodiment, a crystal sheet 4X with a frame is used to form a laminated type of a base substrate 1 and a cover 2. The crystal sheet 4X with a frame includes a crystal sheet 4, a frame 4a surrounding the crystal sheet 4, and a joint portion 4b combining the crystal sheet 4 and the frame 4a at the end sides thereof. Moreover, from two main surfaces of an excitation electrode 7a, extraction electrodes 7b extend through the joint portion 4b as a set of diagonally configured portions of the peripheral frame 4a. Moreover, at least one of the extraction electrodes 7b extends toward an opposite face through the through electrode 11, and a terminal portion 7c is disposed on the same side of the diagonally configured portion.

The base substrate 1 and the cover 2, for example, include a concavity and include crystal or glass. Moreover, the concave side face the two main surfaces of the crystal sheet 4X with a frame, and the peripheral surfaces of the base substrate 1 and the cover 2 are bonded at the frame 4a with the low melting point glass 3. Herein, the peripheral surface of the base substrate 1 having the external terminals 6 and each upper surface of the frame 4a serving as the peripheral surface of the crystal sheet 4X with a frame include concave trenches 9 thereon.

Then, the glass paste 3A is coated on the peripheral surfaces including the concave trenches 9 of the base substrate 1 and the crystal sheet 4X with a frame, and the glass paste 3A is temporarily fixed through calcination. Thereafter, the base substrate 1, the crystal sheet 4X with a frame and the cover 2 are sequentially disposed to be abutted and are then calcined. The peripheral surfaces of the base substrate 1, the crystal sheet 4X with a frame, and the cover 2 are bonded (sealed). Accordingly, the crystal sheet 4 of the crystal sheet 4X with a frame is hermetically enclosed.

In this case, a set of diagonally configured portions of the base substrate 1 corresponding to the terminal portion 7c of the extraction electrode 7b of the crystal sheet 4X with a frame have a metal film (not shown). Moreover, the metal film is electrically connected with the external terminals 6 via the through electrodes 12. Moreover, eutectic alloy 13 such as AuSn is disposed on the metal film, and while the glass paste 3A is heated and melted, the eutectic alloy 13 is melted and is electrically connected with the terminal portion 7c. The melting temperature of the eutectic alloy 13 is, for example, 280° C. in a case of AuSn, which is lower than the melting temperature of the low melting point glass 3, so the two are melted simultaneously.

Further, the third embodiment is also similar to the first embodiment in that, after the sheet base substrate, the sheet cover and the sheet crystal sheet with a frame are bonded; they are partitioned into surface mounting resonators. Additionally, it is only required for the concave trenches 9 to be formed on at least any one of the opposite-facing peripheral surfaces of the base substrate 1, the crystal sheet 4X with a frame, and the cover 2. Moreover, similar to the foregoing, it is only required for the concave trench 9 to be a recess that could enable the filling of the glass paste 3A of the low melting point glass 3. Further, the base substrate 1, the cover 2, and the frame 4a of the crystal sheet 4X with a frame are equivalent to a set of container components in the technical solution.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for manufacturing a surface mounting crystal resonator, wherein the surface mounting crystal resonator comprises a set of container components in a rectangular shape being viewed from the top and having at least a crystal sheet hermetically enclosed therein, and opposite-facing peripheral surfaces of the set of container components are bonded through low melting point glass, the manufacturing method comprising:
forming a set of integrated sheet container components provided with rectangular shaped areas equivalent to the set of container components respectively, and forming a trench on at least any one of the opposite-facing peripheral surfaces of the rectangular shaped areas of the set of sheet container components, wherein the trench surrounds the peripheral surface;
coating a glass paste on the peripheral surface having the trench and performing calcination, so as to temporarily fix the low melting point glass on the peripheral surface;
receiving the crystal sheet in the set of container components,
positioning the peripheral surfaces of the rectangular shaped area by facing the set of sheet container components,
and abutting another peripheral surfaces of the set of sheet container components to the low melting point glass temporarily fixed on one of the peripheral surfaces of the set of sheet container components;
calcining the low melting point glass between the peripheral surfaces of the set of sheet container components, and bonding the peripheral surfaces of the set of container components to form a sheet container; and
vertically and horizontally partitioning the sheet container, so as to obtain individual containers, each having the crystal sheet hermetically enclosed therein.

2. The method for manufacturing a surface mounting crystal resonator according to claim 1, wherein the trench at the peripheral surface and the trench at the peripheral surface of an adjacent surface mounting crystal resonator are formed by setting separate concave trenches between adjacent peripheral surfaces and partitioning between the concave trenches.

3. The method for manufacturing a surface mounting crystal resonator according to claim 1, wherein the trench at the peripheral surface is formed by setting continuous concave trenche between adjacent peripheral surfaces and partitioning the concave trenche.

4. The method for manufacturing a surface mounting crystal resonator according to claim 1, wherein the set of container components comprises a base substrate in a concave shape and a cover in a flat plate shape, or the set of container components comprises a base substrate in a flat plate shape and a cover in a concave shape.

5. The method for manufacturing a surface mounting crystal resonator according to claim 1, wherein the set of container components comprises:
a frame, surrounding the crystal sheet and combined through a joint portion; and
a base substrate and a cover, having peripheral surfaces bonded with two main surfaces of the frame and separated from the crystal sheet.
